(19) United States
(12) Patent Application Publication
(10) Pub. No.: US 2014/0029609 A1
(43) Pub. Date: Jan. 30, 2014

(54) UPDATING TABLE DATA IN NETWORK DEVICE

(71) Applicant: Siamack Ayandeh, Concord, MA (US)

(72) Inventor: Siamack Ayandeh, Concord, MA (US)

(21) Appl. No.: 13/560,332

(22) Filed: Jul. 27, 2012

(51) Int. Cl. H04L 12/56

(52) U.S. Cl. 370/389

(57) ABSTRACT

One example includes a network device. The network device includes a processor and a memory communicatively coupled to the processor. The memory stores instructions causing the processor, after execution of the instructions by the processor, to receive a plurality of frames including table data, each frame including a sequence number, and update a table in the memory based on the table data and the sequence number of each received frame.

### BACKGROUND

Table data (e.g., hard zoning in Fibre Channel (FC) or Fibre Channel over Ethernet (FCoE)) is conventionally configured in a central database and copies of the table data are maintained in control points (e.g., distributed Fibre Channel Forwarder (FCF) switch in a FC/FCoE Storage Area Network (SAN)) and in enforcement points (e.g., FC/FCoE Data Forwarder (FcDF)). The table data is conventionally transmitted from the central database to the control points, and from the control points to the enforcement points over a network that does not guarantee in sequence delivery of frames. Existing transport protocols, such as Transmission Control Protocol (TCP), are complex and resource intensive.

### BRIEF DESCRIPTION OF THE DRAWINGS

FIG. 1 is a block diagram illustrating one example of a network system.

FIG. 2 is a block diagram illustrating another example of a network system.

FIG. 3 is a block diagram illustrating one example of a control point.

FIG. 4 is a block diagram illustrating one example of an enforcement point.

FIG. 5 is a table illustrating one example of zoning rules.

FIG. 6 is a table illustrating one example of an active node list.

FIG. 7 is a diagram illustrating one example implementation of the simple table transfer protocol.

FIG. 8 is a diagram illustrating another example implementation of the simple table transfer protocol.

FIG. 9 is a diagram illustrating another example implementation of the simple table transfer protocol.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined with each other, unless specifically noted otherwise.

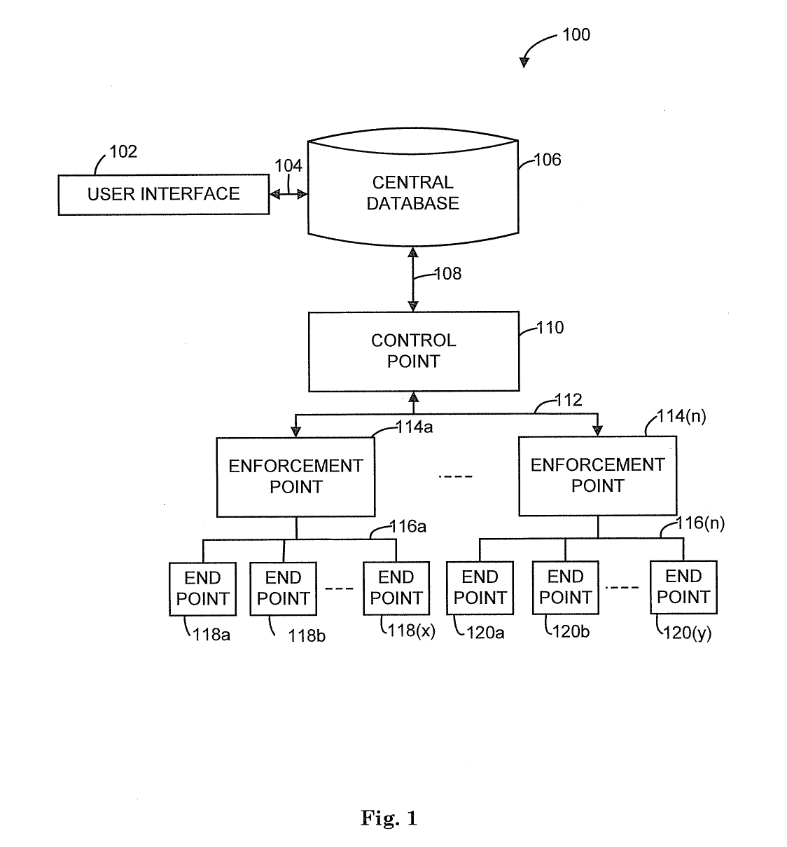

FIG. 1 is a block diagram illustrating one example of a network system 100. Network system 100 includes a user interface 102, a central database 106, a control point 110, enforcement points 114a-114(n), where “n” is any suitable number of enforcement points 114, end points 118a-118(x) (i.e., nodes), where “x” is any suitable number of end points 118, and end points 120a-120(y), where “y” is any suitable number of end points 120. User interface 102 is communicatively coupled to central database 106 through communication link 104. Central database 106 is communicatively coupled to control point 110 through communication link 108. Control point 110 is communicatively coupled to enforcement points 114a-114(n) through communication link 112. Enforcement point 114a is communicatively coupled to end points 118a-118(x) through communication link 116a. Enforcement point 114(n) is communicatively coupled to end points 120a-120(y) through communication link 116(n).

Examples of the disclosure provide a simple table transfer protocol for transferring table data between network devices (e.g., control points and enforcement points) within networks that do not guarantee in sequence delivery of frames. The table data is configured in a central database and copies of the table data are maintained in control points. The simple table transfer protocol is used to transfer updated table data for the activation/deactivation of an end point as well as updated table data for zoning rules for an end point over a network. The most recent entries of the table data are transmitted from the control points to the enforcement points.

The control points transmit each most recent entry of the table data in a frame including a sequence number that is incremented for each subsequently transmitted frame. The frames are received by the enforcement points, which then update their table data based on the table data in the frame and the sequence number. The enforcement points update their table data in response to the sequence number of the received frame being greater than the sequence number of the previously received frame. The enforcement point ignores some or all of the table data in the received frame if the sequence number of the received frame is less than or equal to the sequence number of the previously received frame.

User interface 102 includes a computer or another suitable device. User interface 102 is used to configure tables stored in central database 106. In one example, user interface 102 is used to configure table data for hard zoning in network system 100. Central database 106 stores the hard zoning rules in table form as name based rules. The name based rules include the name of an end point and the list of other end points with which the end point is allowed to communicate.

Control point 110 and enforcement points 114a-114(n) are network devices (e.g., switches) for forwarding communications between end points 118a-118(x) and 120a-120(y) in network system 100. Control point 110 maintains copies of the tables stored in central database 106. The tables stored in control point 110 include name and address based rules. Control point 110 transmits updates to the table data to enforcement points 114a-114(n) in frames, where each frame includes a sequence number that is incremented for each subsequently transmitted frame. Control point 110 may also transmit the entire table to enforcement points 114a-114(n). In this case, in one example, control point 110 resets the sequence number for subsequently transmitted frames including updates to the table data.

End points 118a-118(x) and 120a-120(y) are hosts or other suitable network devices that communicate over network system 100. As end points log into the network, each end point is assigned an identifier or address and becomes active. Once the identifier or address is assigned to the end point, the activation of the end point and the list of other identifiers or addresses, with which the end point is allowed to communicate, are transmitted from a control point to the enforcement point. In one example, the communications of end points 118a-118(x) are regulated by the table data stored in enforcement point 114a, and the communications of end points 120a-120(y) are regulated by the table data stored in enforcement point 114(n). Each row of the table data stored in enforcement points includes the identifier or address of an end point and the identifiers or addresses of the other end points with which the end point is allowed to communicate.

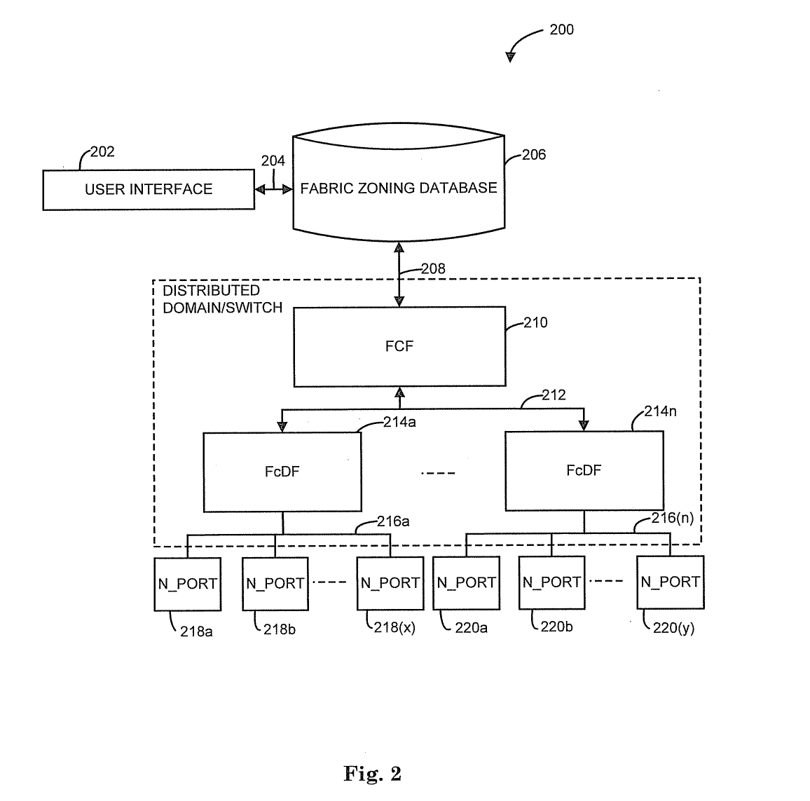

FIG. 2 is a block diagram illustrating another example of a network system 200. Network system 200 includes a user interface 202, a fabric zoning database 206, a distributed domain/switch 209 including a Fibre Channel Forwarder (FCF) 210 and Fibre Channel Data Forwarders (FcDFs) 214a-214(n), where “n” is any suitable number of FcDFs 214, N_Ports 218a-218(x) (i.e., nodes), where “x” is any suitable number of N_Ports 218, and N_Ports 220a-220(y), where “y” is any suitable number of N_Ports 220. User interface 202 is communicatively coupled to fabric zoning database 206 through communication link 204. Fabric zoning database 206 is communicatively coupled to FCF 210 through communication link 208. FCF 210 is communicatively coupled to FcDFs 214a-214(n) through communication link 212. FcDF 214a is communicatively coupled to N_Ports 218a-218(x) through communication link 216a. FcDF 214(n) is communicatively coupled to N_Ports 220a-220(y) through communication link 216(n).

User interface 202 includes a computer or another suitable device. User interface 202 is used to configure tables stored in fabric zoning database 206. In one example, user interface 202 is used to configure table data for hard zoning in network system 200. Fabric zoning database 206 stores the hard zoning ruling in table form as name based rules. The name based rules include the name of an N_Port and the list of other N_Ports with which the N_Port is allowed to communicate.

FCF 210 and FcDF 214a-214(n) are switching network devices for forwarding communications between N_Ports 218a-218(x) and 220a-220(y) in network system 200. FCF 210 maintains copies of the hard zoning tables stored in fabric zoning database 206. The hard zoning tables stored in FCF 210 include name and address based rules. FCF 210 transmits updates to the table data to FcDFs 214a-214(n) in frames, where each frame includes a sequence number that is incremented for each subsequently transmitted frame. FCF 210 may also transmit the entire hard zoning table to FcDFs 214a-214(n). In this case, in one example, FCF 210 resets the sequence number for subsequently transmitted frames including updates to the table data.

N_Ports 218a-218(x) and 220a-220(y) are hosts or other suitable network devices that communicate over network system 200. As end points log into the fabric, each end point is assigned an N_Port Identifier (N_Port_ID) and becomes active. Once the N_Port_ID is assigned to the end point, the activation of the end point and the list of other N_Port IDs, with which the end point is allowed to communicate, are transmitted from an FCF to the FcDF. In one example, the communications of N_Ports 218a-218(x) are regulated by the hard zoning table data stored in FcDF 214a, and the communications of N_Ports 220a-220(y) are regulated by the hard zoning table data stored in FcDF 214(n). Each row of the table data stored in FcDFs includes the N_Port_ID of an end point and the N_Port IDs of the other end points with which the end point is allowed to communicate.

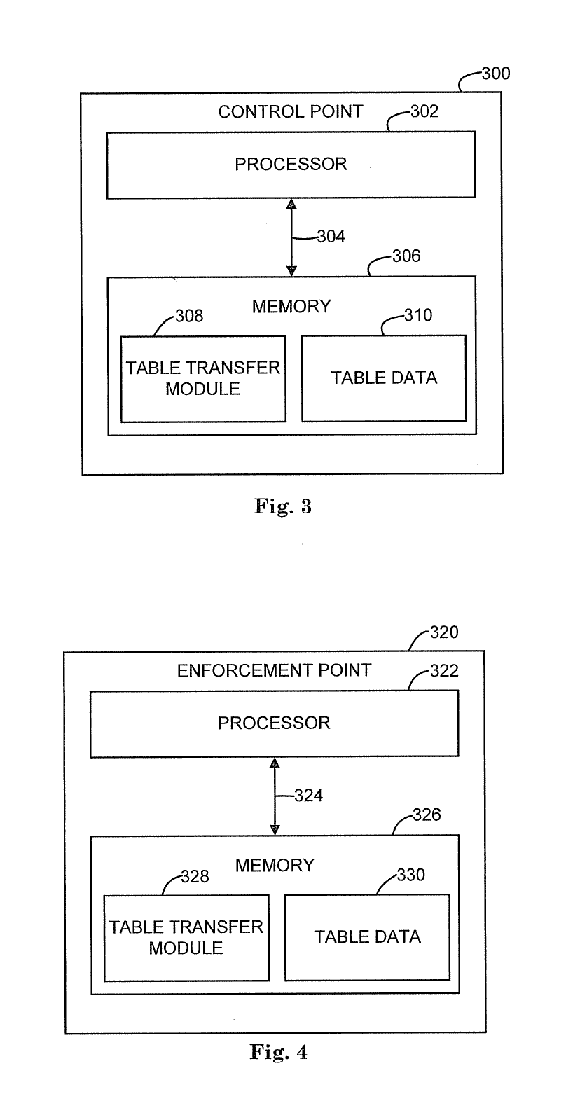

FIG. 3 is a block diagram illustrating one example of a control point 300. In one example, control point 300 provides control point 110 previously described and illustrated with reference to FIG. 1 and FCF 210 previously described and illustrated with reference to FIG. 2. Control point 300 includes a processor 302 and a memory 306. Processor 302 is communicatively coupled to memory 306 through a communication link 304.

Processor 302 includes a Central Processing Unit (CPU) or another suitable processor. In one example, memory 306 stores instructions executed by processor 302 for operating control point 300. Memory 306 includes any suitable combination of volatile and/or non-volatile memory, such as combinations of Random Access Memory (RAM), Read-Only Memory (ROM), flash memory, and/or other suitable memory. Memory 306 stores instructions executed by processor 302 including instructions for a table transfer module 308. In one example, processor 302 executes instructions of table transfer module 308 to implement the simple table transfer protocol disclosed herein.

Memory 306 also stores table data 310. Table data 310 is a copy of the table data stored in a central database, such as central database 106 previously described and illustrated with reference to FIG. 1 or fabric zoning database 206 previously described and illustrated with reference to FIG. 2. The table data 310 stored in memory 306 of control point 300, however, is name and address based. This differs from the table data stored in the central database that is name based.

FIG. 4 is a block diagram illustrating one example of an enforcement point 320. In one example, enforcement point 320 provides each enforcement point 114a-114(n) previously described and illustrated with reference to FIG. 1 and each FcDF 214a-214(n) previously described and illustrated with reference to FIG. 2. Enforcement point 320 includes a processor 322 and a memory 326. Processor 322 is communicatively coupled to memory 326 through a communication link 324.

Processor 322 includes a CPU or another suitable processor. In one example, memory 326 stores instructions executed by processor 322 for operating enforcement point 320. Memory 326 includes any suitable combination of volatile and/or non-volatile memory, such as combinations of RAM, ROM, flash memory, and/or other suitable memory. Memory 326 stores instructions executed by processor 322 including instructions for a table transfer module 328. In one example, processor 322 executes instructions of table transfer module 328 to implement the simple table transfer protocol disclosed herein.

Memory 326 also stores table data 330. Table data 330 is a copy of the table data stored in a control point, such as control point 110 previously described and illustrated with reference to FIG. 1 or FCF 210 previously described and illustrated with reference to FIG. 2. The table data 330 stored in memory 336 of enforcement point 320, however, is address based. This differs from the table data stored in the control point that is name and address based.

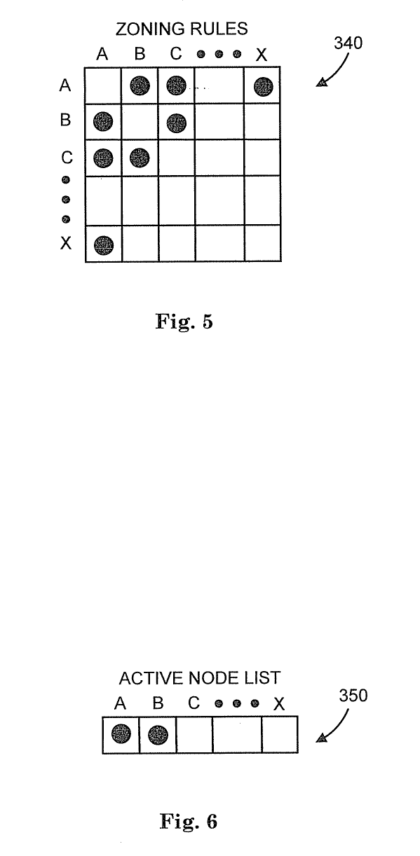

FIG. 5 is a table illustrating one example of zoning rules 340. In one example, the zoning rules 340 are maintained at a control point, such as control point 110 previously described and illustrated with reference to FIG. 1 or FCF 210 previously described and illustrated with reference to FIG. 2. In this example, A, B, C, . . . X represent end points, such as end points 118a-118(x) and 120a-120(y) (FIG. 1) or N_Ports 218a-218(x) and 220a-220(y) (FIG. 2).

Based on the zoning rules 340, in this example, end point A is allowed to communicate with end points B, C, and X. End point B is allowed to communicate with end points A and C. End point C is allowed to communication with end points A and B, and end point X is allowed to communicate with end point A. The zoning rules for each end point are maintained in a peering list of peering information stored in a control point. The peering information defines, for each given end point, the other end points with which the given end point is allowed to communicate. Examples of peering information can include addresses or other suitable identifiers of end points.

FIG. 6 is a table illustrating one example of an active node list 350. Active node list 350 includes end point activation information. The end point activation information indicates whether an end point is active or inactive. In one example, the active node list 350 is maintained at a control point, such as control point 110 previously described and illustrated with reference to FIG. 1 or FCF 210 previously described and illustrated with reference to FIG. 2. In this example, A, B, C, . . . X represent end points, such as end points 118a-118(x) and 120a-120(y) (FIG. 1) or N_Ports 218a-218(x) and 220a-220(y) (FIG. 2).

Based on the active node list 350, in this example, end points A and B are active, and end points C and X are inactive. The zoning rules (FIG. 5) are applied as filters at the enforcement points when the associated end points are active. The zoning rules are removed from the enforcement points when an end point becomes inactive.

The content of zoning rules 340 (FIG. 5) and the content of active node list 350 (FIG. 6) are transferred over a network that does not guarantee the in sequence delivery of frames. Two types of frames are used to transmit the table data from a control point (e.g., an FCF) to enforcement points (e.g., FDFs). The first type of frame includes an end point, which has been activated or deactivated, and peering entries for one or more end points. Each first type of frame has a sequence number that monotonically increases with each new frame. In one example, the first type of frame is an N_Port_ID and Zoning ACL Distribution (NPZD) frame that includes a sequence number. For example, an NPZD frame may include (A+, B, C, X|Y−) indicating that end point A is now active and end point A is allowed to communicate with end points B, C, and X. In addition, end point Y was deactivated.

The second type of frame includes the entire content of the table data and is used to update the tables at the enforcement points infrequently. Each second type of frame has a sequence number that monotonically increases with each new frame. In one example, the second type of frame is an Active Zoning ACL Distribution (AZAD) frame that includes a sequence number. This frame or sequence of frames is useful when a new zone set (i.e., table) has been activated. Control points may maintain multiple versions of the table to represent different peering arrangements. Only one table, however, may be active at any given time for enforcement. In one example, the second type of frame is used to reset the sequence number of the first type of frame.

In operation, each NPZD that is received by an enforcement point is acknowledged. The enforcement points store a sequence number on a per (active) N_Port_ID basis. The enforcement points also store a sequence number on a per N_Port_ID peering entry list basis. The NPZD sequence number is used for both the sequence number per active N_Port_ID and the sequence number per N_Port_ID peering entry. The stored N_Port_ID sequence number is used to determine whether to update the activation/deactivation of an end point at the enforcement points. An arriving activation/deactivation is processed only if the sequence number is greater than the sequence number of the last processed activation/deactivation. If the sequence number is equal to or less than (i.e., the entry is a replication or a late out of sequence entry) the arriving activation/deactivation is ignored.

The peering entry list sequence number is used to determine whether to update the peering entries at the enforcement points. The arriving peering entry is processed only if the sequence number is greater than the sequence number of the last processed peering entry. If the sequence number is equal to or less than (i.e., the entry is a replication or a late out of sequence entry) the peering entry is ignored. In one example, any lost or corrupted frames are resent through a time out mechanism.

Since a peering entry is anchored on an end point (e.g., host) and contains the latest view of the desired enforcement rules, the table transfer protocol ensures that the ACL entries used to enforce filtering remain up to date on a per active end point basis.

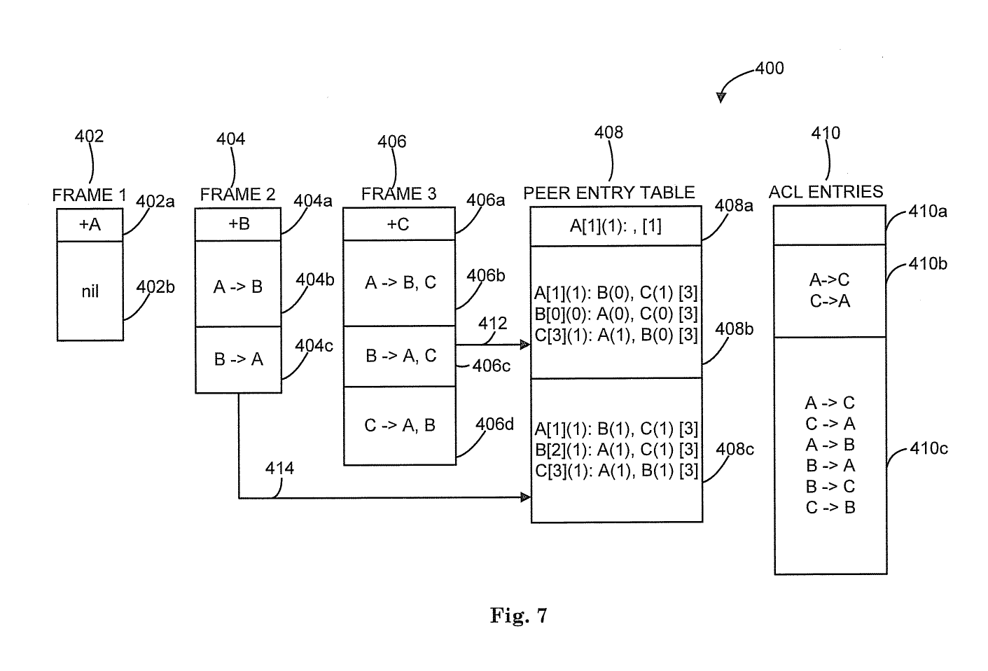

FIG. 7 is a diagram illustrating one example implementation 400 of the simple table transfer protocol. Example implementation 400 includes frames 402, 404, and 406 transmitted from a control point to an enforcement point. The enforcement point maintains a peer entry table 408 and Access Control List (ACL) entries 410. In peer entry table 408, the notation “(0)” indicates that an end point is inactive, “(1)” indicates that an end point is active, “X[x]” indicates an activation sequence number “x” for end point “X,” and “[x]” indicates a peer entry sequence number.

In this example, frame two 404 and frame three 406 arrive out of order. Frame one 402 includes fields 402a and 402b and has sequence number 1. Field 402a indicates that end point A has been activated, and field 402b indicates that there are no zoning rule updates. In response to receiving frame one 402, peer entry table 408 is updated to indicate that end point A is active. As indicated at 408a, peer entry table 408 is updated such that “A[1](1)” indicates that end point A is active and sequence number 1 has been stored as the activation sequence number for active end point A. In addition, as indicated at 408a, peer entry table 408 is updated such that “[1]” indicates that the sequence number 1 has been stored as the peer entry sequence number. ACL entry 410a is empty since only end point A is active.

Frame three 406 includes fields 406a-406d and has sequence number 3. Field 406a indicates that end point C has been activated. Field 406b indicates that the zoning rules for end point A have been updated such that end point A may communicate with end points B and C. Field 406c indicates that the zoning rules for end point B have been updated such that end point B may communicate with end points A and C. Field 406d indicates that the zoning rules for end point C have been updated such that end point C may communicate with end points A and B.

In response to receiving frame three 406 as indicated 412, peer entry table 408 is updated since the sequence number 3 is greater than the sequence number 1 of the previously received frame one 402. As indicated at 408b, “C[3](1)” indicates that end point C is now active and sequence number 3 has been stored as the activation sequence number for active end point C. The zoning rules for end point A have been updated to allow end point A to communicate with end points B and C. End point B, however, is not active as indicated at 408b by “A[1](1): B(0), C(1).” The zoning rules for end point B have been updated to allow end point B to communicate with end points A and C. End point B, however, is not active as indicated at 408b by “B[0](0): A(0), C(0).” The zoning rules for end point C have been updated to allow end point C to communicate with end points A and B. End point B, however, is not active as indicated at 408b by “C[3](1): A(1), B(0).” In addition, as indicated at 408b, peer entry table 408 is updated such that “[3]” indicates that the sequence number 3 has been stored as the peer entry sequence number. Accordingly, ACL entry 410b indicates that end point A may communicate with end point C, and end point C may communicate with end point A.

Frame two 404 includes fields 404a-404c. Field 404a indicates that end point B has been activated. Field 404b indicates that the zoning rules for end point A have been updated such that end point A may communicate with end point B. Field 404c indicates that the zoning rules for end point B have been updated such that end point B may communicate with end point A.

In response to receiving frame two 404 as indicated at 414, the active end point entries of peer entry table 408 are updated but the zoning rule updates are ignored since the sequence number 2 is less than the sequence number 3 of the previously received frame three 406. In this case, field 404a of frame two 404 is used to update peer entry table 408 while fields 404b and 404c are ignored. Therefore, as indicated at 408c, “B[2](1)” indicates that end point B is now active and sequence number 2 has been stored as the activation sequence number for active end point B. “A[1](1): B(1), C(1)” indicates that since end point B is now active, end point A may now communicate with end point B in addition to end point C. “B[2](1): A(1), C(1)” indicates that since end point B is now active, end point B may now communicate with end points A and C. “C[3](1): A(1), B(1)” indicates that since end point B is now active, end point C may now communicate with end point B in addition to end point A. Accordingly, ACL entry 410c indicates that end point A may communicate with end points C and B, end point B may communicate with end points A and C, and end point C may communicate with end points A and B.

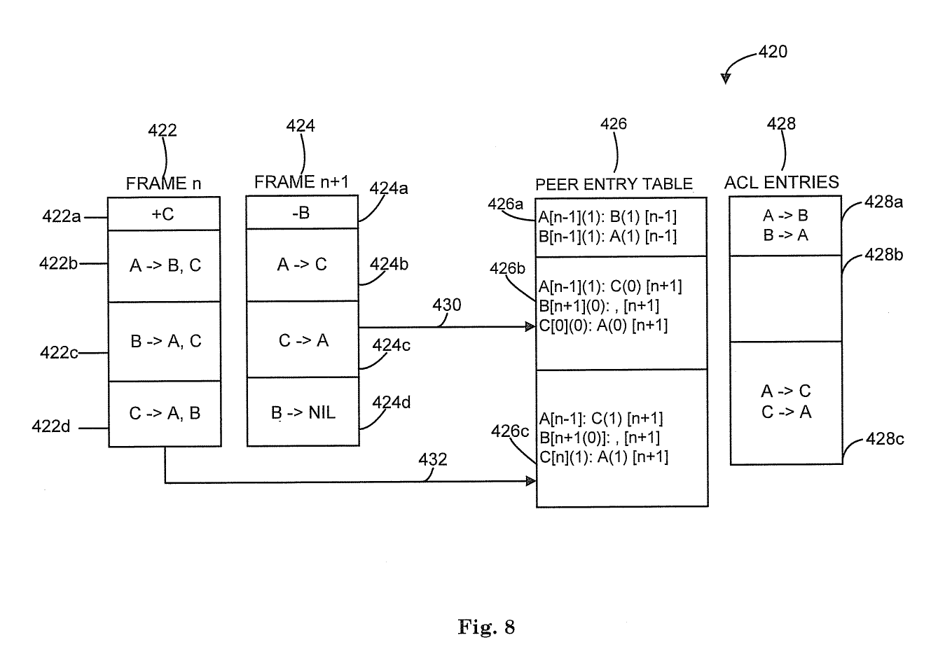

FIG. 8 is a diagram illustrating another example implementation 420 of the simple table transfer protocol. Example implementation 420 includes frames 422 and 424 transmitted from a control point to an enforcement point. The enforcement point maintains a peer entry table 426 and ACL entries 428. In peer entry table 426, the notation “(0)” indicates that an end point is inactive, “(1)” indicates that an end point is active, “X[x]” indicates an activation sequence number “x” for end point “X,” and “[x]” indicates a peer entry sequence number.

In this example, end points A and B are already active and zoning rules are in place to allow end point A to communicate with end point B, and to allow end point B to communicate with end point A. This is indicated in peer entry table 426 at 426a by “A[n−1](1): B(1) [n−1]” and “B[n−1](1): A(1) [n−1]” and by ACL entry 428a, where “n−1” indicates the sequence number of a previously received frame.

In this example frame n 422 and frame n+1 424 arrive out of order. Frame n+1 424 includes fields 424a-424d and has sequence number n+1. Field 424a indicates that end point B has been deactivated. Field 424b indicates that the zoning rules for end point A have been updated such that end point A may communicate with end point C. Field 424c indicates that the zoning rules for end point C have been updated such that end point C may communicate with end point A. Field 424d indicates that the zoning rules for end point B, which has been deactivated, have been updated such that end point B may not communicate with any other end points.

In response to receiving frame n+1 424 as indicated at 430, peer entry table 426 is updated since the sequence number n+1 is greater than the sequence number n−1 of the previously received frame. As indicated at 426b, “B[n+1](0)” indicates that end point B is now inactive and sequence number n+1 has been stored as the activation sequence number for end point B. The zoning rules for end point A have been updated to allow end point A to communicate with end point C. End point C, however, is not active as indicated at 426b by “A[n−1](1): C(0).” The zoning rules for end point C have been updated to allow end point C to communicate with end point A. End point C, however, is not active as indicated at 426b by “C[0](0): A(0).” In addition, as indicated at 426b, peer entry table 426 is updated such that “[n+1]” indicates that the sequence number n+1 has been stored as the peer entry sequence number. Accordingly, ACL entry 428b is empty since no end points may communicate with each other.

Frame n 422 includes fields 422a-422d and has sequence number n. Field 422a indicates that end point C has been activated. Field 422b indicates that the zoning rules for end point A have been updated such that end point A may communicate with end points B and C. Field 422c indicates that the zoning rules for end point B have been updated such that end point B may communicate with end points A and C. Field 422d indicates that the zoning rules for end point C have been updated such that end point C may communicate with end points A and B.

In response to receiving frame n 422 as indicated at 432, the active end point entries of peer entry table 426 are updated but the zoning rule updates are ignored since the sequence number n is less than the sequence number n+1 of the previously received frame n+1 424. In this case, field 422a of frame n 422 is used to update peer entry table 426 while fields 422b-422d are ignored. Therefore, as indicated at 426c, “C[n](1)” indicates that end point C is now active and sequence number n has been stored as the activation sequence number for active end point C. “A[n−1](1): C(1)” indicates that since end point C is now active, end point A may now communicate with end point C. “C[n](1): A(1)” indicates that since end point C is now active, end point C may now communicate with end point A. Accordingly, ACL entry 428c indicates that end point A may communicate with end point C, and end point C may communicate with end point A.

The entry “B[n+1](0)”, as indicated at 426b and 426c, is marked for deletion but maintained in one example for two times a timeout interval to ensure that all out of sequence frames have been received and processed. Once two times the timeout interval, or another suitable interval, has elapsed, the entry is deleted.

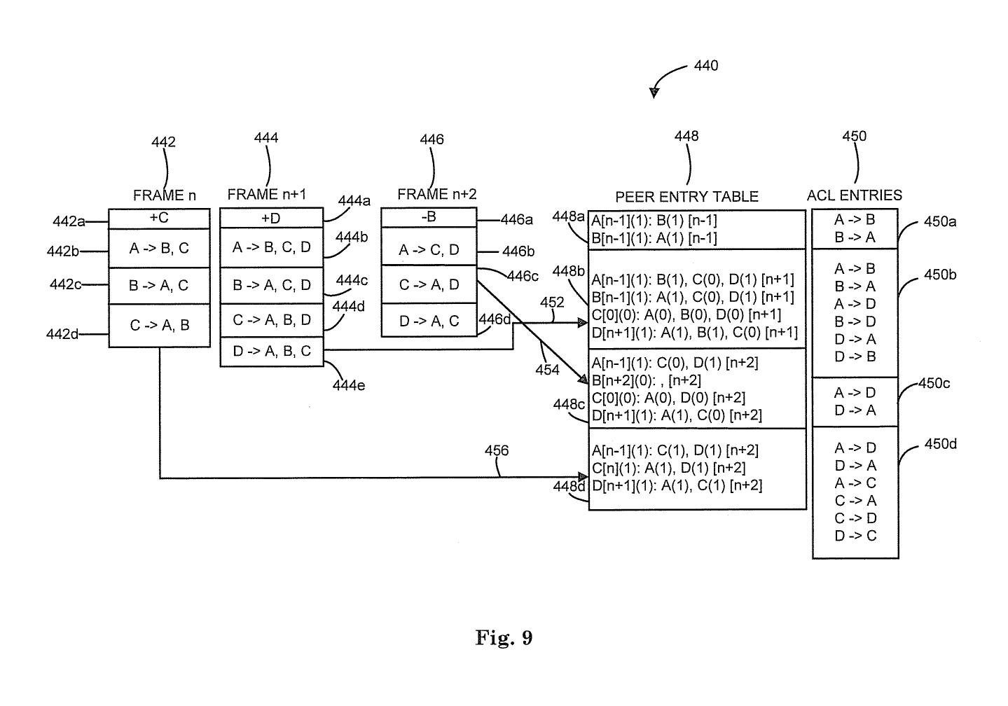

FIG. 9 is a diagram illustrating another example implementation 440 of the simple table transfer protocol. Example implementation 440 includes frames 442, 444, and 446 transmitted from a control point to an enforcement point. The enforcement point maintains a peer entry table 448 and ACL entries 450. In peer entry table 448, the notation “(0)” indicates that an end point is inactive, “(1)” indicates that an end point is active, “X[x]” indicates an activation sequence number “x” for end point “X,” and “[x]” indicates a peer entry sequence number.

In this example end points A and B are already active and zoning rules are in place to allow end point A to communicate with end point B, and to allow end point B to communicate with end point A. This is indicated in peer entry table 448 at 448a by “A[n−1](1): B(1) [n−1]” and “B[n−1](1): A(1) [n−1]” and by ACL entry 450a, where “n−1” indicates the sequence number of a previously received frame. In this example frame n 442 arrives after frame n+2 446.

Frame n+1 444 includes fields 444a-444e and has sequence number n+1. Field 444a indicates that end point D has been activated. Field 444b indicates that the zoning rules for end point A have been updated such that end point A may communicate with end points B, C, and D. Field 444c indicates that the zoning rules for end point B have been updated such that end point B may communicate with end points A, C, and D. Field 444d indicates that the zoning rules for end point C have been updated such that end point C may communicate with end points A, B, and D. Field 444e indicates that the zoning rules for end point D have been updated such that end point D may communicate with end points A, B, and C.

In response to receiving frame n+1 444 as indicated at 452, peer entry table 448 is updated since the sequence number n+1 is greater than the sequence number n−1 of the previously received frame. As indicated at 448b, “D[n+1](1)” indicates that end point D is now active and sequence number n+1 has been stored as the activation sequence number for end point D. The zoning rules for end point A have been updated to allow end point A to communicate with end points B, C, and D. End point C, however, is not active as indicated at 448b by “A[n−1](1): B(1), C(0), D(1).” The zoning rules for end point B have been updated to allow end point B to communicate with end points A, C, and D. End point C, however, is not active as indicated at 448b by “B[n−1](1): A(1), C(0), D(1).” The zoning rules for end point C have been updated to allow end point C to communicate with end points A, B, and D. End point C, however, is not active as indicated at 448b by “C[0](0): A(0), B(0), D(0).” The zoning rules for end point D have been updated to allow end point D to communicate with end points A, B, and C. End point C, however, is not active as indicated at 448b by “D[n+1](1): A(1), B(1), C(0).” In addition, as indicated at 448b, peer entry table 448 is updated such that “[n+1]” indicates that the sequence number n+1 has been stored as the peer entry sequence number. Accordingly, ACL entry 450b indicates that end point A may communicate with end points B and D, end point B may communicate with end points A and D, and end point D may communicate with end points A and B.

Frame n+2 446 includes fields 446a-446d and has sequence number n+2. Field 446a indicates that end point B has been deactivated. Field 446b indicates that the zoning rules for end point A have been updated such that end point A may communicate with end points C and D. Field 446c indicates that the zoning rules for end point C have been updated such that end point C may communicate with end points A and D. Field 446d indicates that the zoning rules for end point D have been updated such that end point D may communicate with end points A and C.

In response to receiving frame n+2 446 as indicated at 454, peer entry table 448 is updated since the sequence number n+2 is greater than the sequence number n+1 of the previously received frame. As indicated at 448c, “B[n+2](0)” indicates that end point B is now inactive and sequence number n+2 has been stored as the activation sequence number for end point B. The zoning rules for end point A have been updated to allow end point A to communicate with end points C and D. End point C, however, is not active as indicated at 448c by “A[n−1](1): C(0), D(1).” The zoning rules for end point C have been updated to allow end point C to communicate with end points A and D. End point C, however, is not active as indicated at 448c by “C[0](0): A(0), D(0).” The zoning rules for end point D have been updated to allow end point D to communicate with end points A and C. End point C, however, is not active as indicated at 448c by “D[n+1](0): A(1), C(0).” In addition, as indicated at 448c, peer entry table 448 is updated such that “[n+2]” indicates that the sequence number n+2 has been stored as the peer entry sequence number. Accordingly, ACL entry 450c indicates that end point A may communicate with end point D, and end point D may communicate with end point A.

Frame n 442 includes fields 442a-442d and has sequence number n. Field 442a indicates that end point C has been activated. Field 442b indicates that the zoning rules for end point A have been updated such that end point A may communicate with end points B and C. Field 442c indicates that the zoning rules for end point B have been updated such that end point B may communicate with end points A and C. Field 442d indicates that the zoning rules for end point C have been updated such that end point C may communicate with end points A and B.

In response to receiving frame n 442 as indicated at 456, the active end point entries of peer entry table 448 are updated but the zoning rule updates are ignored since the sequence number n is less than the sequence number n+2 of the previously received frame n+2 446. In this case, field 422a of frame n 442 is used to update peer entry table 448 while fields 442b-442d are ignored. Therefore, as indicated at 448d, “C[n](1)” indicates that end point C is now active and sequence number n has been stored as the activation sequence number for active end point C. “A[n−1](1): C(1), D(1)” indicates that since end point C is now active, end point A may now communicate with end point C. “C[n](1): A(1), D(1)” indicates that since end point C is now active, end point C may now communicate with end points A and D. “D[n+1](1): A(1), C(1)” indicates that since end point C is now active, end point D may now communicate with end points A and C. Accordingly, ACL entry 450d indicates that end point A may communicate with end points D and C, end point D may communicate with end points A and C, and end point C may communicate with end points A and D.

Examples of the disclosure provide a simple table transfer protocol for transferring table data between devices over a network that does not guarantee in sequence delivery of frames. The simple table transfer protocol allows for individual node peering entries to be processed independently, even with out of sequence frames, with no additional delays. The protocol avoids wait times and idle times and does not introduce any additional frames on the wire.

Although specific examples have been illustrated and described herein, it will be appreciated by those of ordinary skill in the art that a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A network device comprising:
a processor; and
a memory communicatively coupled to the processor, the memory storing instructions causing the processor, after execution of the instructions by the processor, to:
receive a plurality of frames including table data, each frame including a sequence number; and
update a table in the memory based on the table data and the sequence number of each received frame.

2. The network device of claim 1, wherein the memory stores instructions causing the processor, after execution of the instructions by the processor, to:
update the table in the memory in response to the sequence number of a received frame being greater than a sequence number of a previously received frame.

3. The network device of claim 1, wherein the table data includes peering information and end point activation information.

4. The network device of claim 3, wherein the memory stores instructions causing the processor, after execution of the instructions by the processor, to:
store the sequence number of each received frame in the table in the memory on a per active end point basis.

5. The network device of claim 3, wherein the memory stores instructions causing the processor, after execution of the instructions by the processor, to:
store the sequence number of each received frame in the table in the memory on a per peering entry list basis.

6. A network device comprising:
a processor; and
a memory communicatively coupled to the processor, the memory storing instructions causing the processor, after execution of the instructions by the processor, to:
receive table data from a central database; and
transmit a plurality of frames including the table data, each frame including a sequence number, to a further network device to update a table in the further network device based on the table data and the sequence number of each transmitted frame.

7. The network device of claim 6, wherein the table data includes peering information and end point activation information.

8. The network device of claim 6, wherein the network device comprises a control point, and
wherein the further network device comprises an enforcement point.

9. The network device of claim 8, wherein the central database comprises a fabric zoning database,
wherein the control point comprises a Fibre Channel Forwarder (FCF) of a distributed switch, and
wherein the enforcement point comprises a Fibre Channel Data Forwarder (FcDF) of the distributed switch.

10. The network device of claim 6, wherein the memory stores instructions causing the processor, after execution of the instructions by the processor, to:
retransmit lost or corrupted frames to the further network device.

11. A method for updating table data in a network device, the method comprising:
receiving, from a further network device, a plurality of frames comprising table data, each frame comprising a sequence number; and
updating a table in the network device based on the table data and the sequence number of each received frame.

12. The method of claim 11, wherein the table data comprises peering information and node activation information, the method further comprising:
storing the sequence number of each received frame in the table in the network device on a per active node basis; and
storing the sequence number of each received frame in the table in the network device on a per peering entry list basis.

13. The method of claim 12, further comprising:
updating the activation information in the table in the network device in response to the sequence number of a received frame being greater than the stored sequence number of an active node; and
updating the peering information in the table in the network device in response to the sequence number of a received frame being greater than the stored sequence number of the peering entry list.

14. The method of claim 12, further comprising:
ignoring the activation information in response to the sequence number of a received frame being less than or equal to the stored sequence number of an active node; and
ignoring the peering information in response to the sequence number of a received frame being less than or equal to the stored sequence number of the peering entry list.

15. The method of claim 11, further comprising:
resetting the sequence number in response to an Active Zoning Access Control List (ACL) Distribution (AZAD) frame.
